(19) United States
(12) Patent Application Publication
(10) Pub. No.: US 2019/0331496 A1
(43) Pub. Date: Oct. 31, 2019

(54) LOCATING A VEHICLE

(71) Applicant: COMMISSARIAT A L'ENERGIE ATOMIQUE ET AUX ENERGIES ALTERNATIVES, Paris (FR)

(72) Inventors: Yoann DHOME, Clermont-Ferrand (FR); Mathieu CARRIER, Meudon (FR); Vincent GAY-BELLILE, Paris (FR)

(73) Assignee: COMMISSARIAT A L'ENERGIE ATOMIQUE ET AUX ENERGIES ALTERNATIVES, Paris (FR)

(21) Appl. No.: 16/469,013

(22) PCT Filed: Dec. 13, 2017
(86) PCT No.: PCT/FR2017/053551

§ 371 Date: Jun. 12, 2019

(30) Foreign Application Priority Data
Dec. 14, 2016 (FR) 1662420

(51) Int. Cl. G01C 21/20; G05D 1/02; G06T 7/73; G06K 9/00; G06K 9/62

(52) U.S. Cl. CPC G01C 21/20; G05D 1/0274; G05D 1/0251; G06T 7/73; G06T 2207/30252; G06K 9/6201; G05D 2201/0213; G06T 2207/30244; G06K 9/00791

(57) ABSTRACT

A method for locating a vehicle, including at least one vision sensor and at least one item of equipment from among an inertial navigation unit, a satellite navigation module and an odometry sensor. The method including carrying out vision-localization from image data supplied by the at least one vision sensor, to produce first location data, and applying a Bayesian filtering via a Kalman filter, taking into account the first location data, to the data derived from the at least one item of equipment and the data from a scene model, to produce second data for locating the vehicle.

### TECHNICAL FIELD

The present invention relates to the localization in real time of a vehicle.

The applications of the invention are, for example, the vehicle driving assistance, the autonomous driving or even the augmented reality.

### STATE OF THE PRIOR ART

In the railway sector, localization modules presented in the article: “Simultaneous Localization and Mapping for Path-Constrained Motion” by Carsten Hasberg, Stefan Hensel, and Christoph Stiller, IEEE Transactions on intelligent Transportation Systems, Vol. 03, No. 2, June 2012, or in the article: “Bayesian Train Localization Method Extended By 3D Geometric Railway Track Observations From Inertial Sensors” by Oliver Heirich, Patrick Robertson, Adrian Cardalda Garcla and Thomas Strang, 2012, or also in the article: “RailSLAM—Localization of Rail Vehicles and Mapping of Geometric Railway Tracks” by Oliver Heirich, Patrick Robertson and Thomas Strang, IEEE International Conference on Robotics and Automation (ICRA), May 2013, aim at geo-localizing trains in order to avoid accidents and collisions. The localization provided by these approaches is based on the fusion of data derived from GPS sensors and odometric sensors through a Bayesian filter integrating constraints provided by a polynomial model representing railway tracks.

These methods do not offer enough accuracy to be able to achieve an application of augmented reality or of partial or total automation of a vehicle driving. Indeed, they rely mainly on the GPS sensor and do not compensate for the uncertainties of positioning of this sensor in the city due to the phenomena of multi-echoes, occlusions of part of the satellite constellation, or “canyon” effect.

Augmented reality applications are presented for example in document EP 2 731 084. The article “Scalable 6-DOF Localization on Mobile Devices” by Sven Middelberg, Torsten Sattler, Ole Untzelmann and Leif Kobbelt, 2014, as well as document FR 2 976 107 offer an accurate localization solution based on a vision sensor and a SLAM (Simultaneous Localization And Mapping)-type algorithm. The method triangulates environment points, called points of interest, to calculate the displacement of the camera between two successive images. Using a bundle adjustment, it performs a robust calculation that challenges locally the path traveled. This type of approach, calculating relative displacements between images, accumulates over time uncertainties and errors.

To limit this phenomenon, document FR 2976 107 makes use of a model of the scene to introduce constraints within the bundle adjustment step.

However, the gain in robustness and accuracy of this input is strongly dependent on the viewpoint, on the complexity of the object(s) described in the model and on the constraints deduced.

The article “Scalable 6-DOF Localization on Mobile Devices” uses a viewpoint recognition module making use of a base of geo-referenced visual landmarks to limit the drift phenomenon described above.

However, the viewpoint recognition module is very sensitive to the occlusions and robustness of the signature of the visual landmarks (weather-related variations, changes in lighting, seasons . . . ).

Thus, these methods do not provide sufficient robustness for an accurate absolute localization of a vehicle, for example for a long car journey.

Vehicle localization applications use a localization from a vision sensor.

Thus, the article: “Vision-Based Differential GPS: Improving VSLAM/GPS Fusion in Urban Environment with 3D Building Models” by Dorra Larnaout, Vincent Gay-Belllile, Steve Bourgeois and Michel Dhome, Second International Conference on 3D Vision, 2014, uses a SLAM (Simultaneous Localization and Mapping)-type algorithm. The algorithm is here completed by two elements: the addition of a module for correcting biases of the GPS sensor via a scene model and the integration of constraints at the step of adjusting bundles from data derived from the GPS sensor.

The article “Collaborative Methods for Real-time Localization in Urban Centers” by S. Peyraud et al., International Journal of Advanced Robotic Systems, 2015, discloses a method for localizing a vehicle in an urban environment.

This method firstly includes a visual localization based on a recognition of viewpoints from a base of geo-referenced visual landmarks. This module includes a step of detecting and pairing points of interests followed by an adjustment of bundles constrained by the visual landmark base.

When the result of the visual localization is unsatisfactory, an alternative localization includes a Bayesian filtering constrained by a traffic lane model and merging GPS and odometric data.

This method relies on two relatively fragile modules and makes use of them alternately, which is not a real source of reliability.

The reliability of the viewpoint recognition is related to the robustness of the signature of the identified visual landmarks relative to the weather and brightness variations, to the occlusions of the scene and to the differences in position and angles of viewpoints.

The Bayesian filter module merges data derived from odometric sensors and GPS data. However, an odometric sensor is known to drift over time for extrinsic (slips of the wheels on the ground) and intrinsic (time integration of a relative motion) reasons. The GPS sensor, for its part, is known to encounter problems in urban areas (multi-echoes, occlusions of part of the satellite constellation, “canyon” effect). Even with a very accurate GPS system, for example of the GPS-RTK type, it is very likely to encounter positioning errors of several meters in urban areas.

### DISCLOSURE OF THE INVENTION

The invention aims at solving the problems of the prior art by providing a method for localizing a vehicle including at least one vision sensor and at least one equipment among an inertial unit, a satellite navigation module and an odometric sensor, the method including a step of:
vision-localization from image data provided by the at least one vision sensor, to produce first localization data, characterized in that the vision-localization step includes steps of:
   determining relative vision constraints by a method for simultaneous localization and mapping applied to the image data produced by the at least one vision sensor,
   determining absolute vision constraints by recognition of viewpoints from image data produced by the at least one vision sensor and a base of visual landmarks,
   adjusting constrained bundles taking into account the relative and absolute vision constraints, constraints defined from a scene model and constraints defined from data produced by at least one equipment among the inertial unit and the satellite navigation module,

and characterized in that the method includes a step of:
Bayesian filtering by a Kalman filter taking into account the first localization data, data derived from the at least one equipment and data of the scene model, to produce second vehicle localization data.

Thanks to the invention, the localization of a vehicle is determined in absolute, accurate and robust manners in real time.

The localization is absolute because it provides a geo-referenced and oriented positioning. The localization is accurate because it provides the position and orientation of the vehicle with an accuracy of a few centimeters and a few tenths of degrees.

The Bayesian filtering takes into account data derived from sensors of different types.

The bundle adjustment takes into account data derived from sensors of different types.

According to a preferred characteristic, the vision-localization step further includes a step of:
correcting the sensor biases using the visual landmark base and the scene model.

According to one preferred characteristic, the step of Bayesian filtering by a Kalman filter also takes into account data among:
data derived from the satellite navigation module,
data derived from the odometric sensor,
data derived from the inertial unit.

According to a preferred characteristic, the step of determining relative constraints includes steps of:
detecting and matching points of interest in images provided by the at least one vision sensor,
calculating the installation of the vision sensor from the matching of points of interest,
selecting keyframes,
triangulating 3D points.

The invention also relates to a device for localizing a vehicle including at least one vision sensor, at least one equipment among an inertial unit, a satellite navigation module and an odometric sensor, and means for:
vision-localization from image data provided by the at least one vision sensor, to produce first localization data,

characterized in that the vision-localization means include means for:
determining relative vision constraints by a method for simultaneous localization and mapping applied to the image data produced by the at least one vision sensor,
determining absolute vision constraints by recognition of viewpoints from image data produced by the at least one vision sensor and a base of visual landmarks,
adjusting constrained bundles taking into account the relative and absolute vision constraints, constraints defined from a scene model and constraints defined from data produced by at least one equipment among the inertial unit and the satellite navigation module,

And in that the device includes Bayesian filtering means implementing a Kalman filter taking into account the first localization data, data derived from the at least one equipment and data of a scene model, to produce second vehicle localization data.

The device has advantages similar to those presented previously.

In a particular embodiment, the steps of the method according to the invention are implemented by computer program instructions.

Consequently, the invention also relates to a computer program on an information medium, this program being likely to be implemented in a computer, this program including instructions adapted to the implementation of the steps of a method as described above.

This program can use any programming language, and be in the form of source code, object code, or intermediate code between source code and object code, such as in a partially compiled form, or in any other form desirable form.

The invention also relates to a computer-readable information medium, and including computer program instructions suitable for the implementation of the steps of a method as described above.

The information medium may be any entity or device capable of storing the program. For example, the medium may include a storage means, such as a ROM, for example a CD-ROM or a microelectronic circuit ROM, or a magnetic recording means, for example a floppy disk or a hard disk.

On the other hand, the information medium may be a transmissible medium such as an electrical or optical signal, which may be conveyed via an electrical or optical cable, by radio or by other means. The program according to the invention can be in particular downloaded on an Internet-type network.

Alternatively, the information medium may be an integrated circuit in which the program is incorporated, the circuit being adapted to execute or to be used in the execution of the method according to the invention.

### BRIEF DESCRIPTION OF THE DRAWINGS

Other characteristics and advantages will become apparent upon reading the following description of a preferred embodiment, given by way of non-limiting example, described with reference to the figures in which:

FIG. 1 represents an embodiment of a vehicle localization device according to the present invention,

FIG. 2 represents an embodiment of a vehicle localization method according to the present invention,

FIG. 3 represents an embodiment of a step of localizing a vehicle by vision, included in the method of FIG. 2, and

FIG. 4 represents an embodiment of a Bayesian filtering step included in the method of FIG. 2.

### DETAILED DISCLOSURE OF PARTICULAR EMBODIMENTS

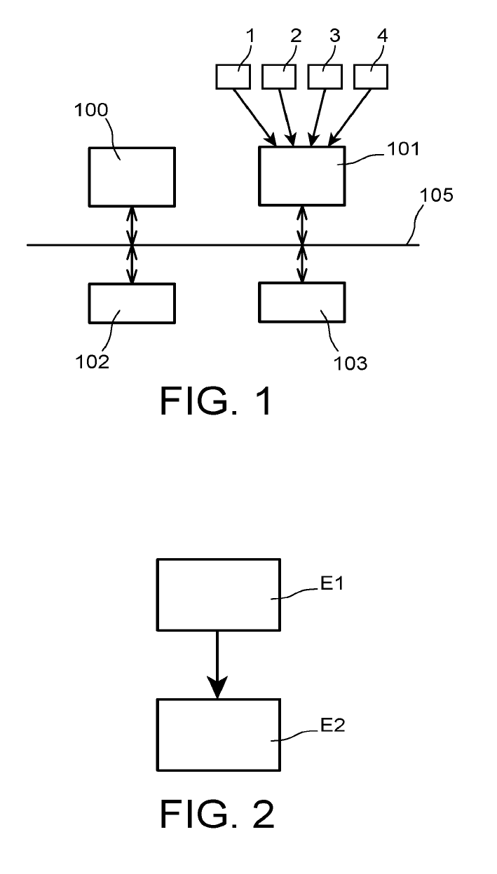

According to a preferred embodiment, represented in FIG. 1, a device for localizing a vehicle includes a set of sensors installed on the vehicle. These sensors are:
at least one vision sensor 1 that provides image data of the vehicle environment,
a satellite navigation module 2 called GNSS “Global Navigation Satellite System”,
an odometric sensor 3, and
an inertial unit 4.

In particular, the vision sensor 1 is a perspective monocular camera whose intrinsic parameters are known and fixed.

It should be noted that the satellite navigation module 2, the odometric sensor 3 and the inertial unit 4 constitute optional equipment. The vehicle localization device can therefore include only two of them, or only one of them. The satellite navigation module 2 is for example a GPS (Global Positioning System) module.

These sensors are connected to a data processing module that has the general structure of a computer. It includes in particular a processor 100 running a computer program implementing the method according to the invention, an input interface 101, a memory 102 and an output interface 103.

These different elements are conventionally connected by a bus 105.

The input interface 101 is intended to receive the data provided by the sensors fitted to the vehicle.

The processor 100 executes the processing operations disclosed in the following. These processing operations are carried out in the form of code instructions of the computer program that are stored by the memory 102 before being executed by the processor 100.

An MS scene model is stored in the memory 102. The MS scene model is a model of the a priori knowledge of the environment in which the vehicle will progress. This may be a model of traffic lanes and/or a 3D model of buildings.

The output interface 103 provides the absolute position and orientation in real time of the vehicle.

According to a preferred embodiment, represented in FIG. 2, the vehicle localization method includes two main steps E1 and E2.

Step E1 is a localization of the vehicle by vision. The vision-localization makes use of the image data provided by the vision sensor 1 to produce first vehicle localization data.

Step E1 is followed by step E2 which is a Bayesian filtering of a set of data to produce second vehicle localization data that are more precisely the position and orientation in real time of the vehicle. Thus, the first vehicle localization data are part of the set of data processed by the Bayesian filtering. This set of data also includes data of the scene model MS and data provided by at least one of the other sensors 2, 3 and 4 fitted to the vehicle.

Steps E1 and E2 are detailed below.

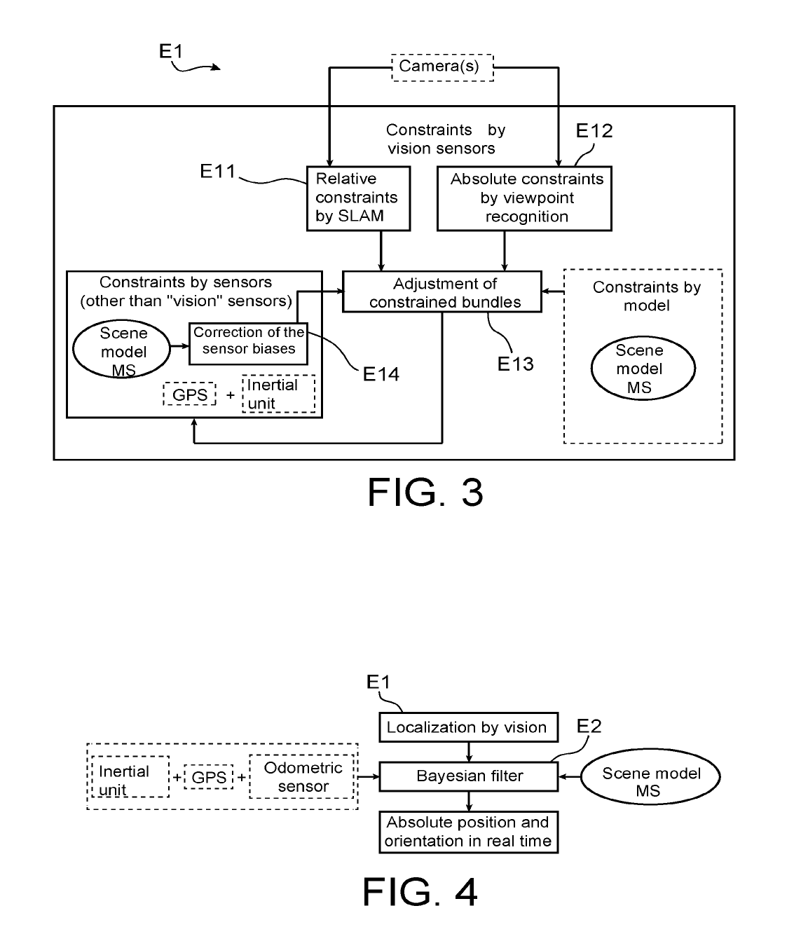

FIG. 3 represents an embodiment of step E1 of localizing the vehicle by vision. Step E1 includes steps E11 to E14.

Step E11 takes into account image data provided by the vision sensor 1 fitted to the vehicle. Step E11 is a determination of relative constraints, carried out based on a method for Simultaneous Localization And Mapping called SLAM, applied to the image data. Step E11 results in 2D-3D correspondences between keyframes. These correspondences constitute relative constraints on the displacement of the camera 1.

More precisely, the SLAM method determines the position of the camera 1 and its orientation at different times of a sequence, as well as the position of a set of 3D points observed throughout the sequence.

Step E11 includes a detection of points of interest in the images provided by the vision sensor 1, then a matching of the points of interest from one image to the other. The matching is carried out by a comparison from one image to the other of descriptors, or characteristic vectors, of areas of interest corresponding to points of interest.

Then, from the correspondences of points of interest, the position and the orientation of the (calibrated) camera are determined from already reconstructed 3D points and their 2D coordinates in the current image. It is therefore the determination of the installation of the camera from 3D/2D correspondences. For this, the measurement used is the re-projection error. It consists in measuring the 2D distance between the observation of a 3D point in the image, i.e. the 2D position of the point of interest, and the projection of the 3D point reconstructed in this same image.

A time sub-sampling is then performed and some images are automatically selected as keyframes for a triangulation of the 3D points. The keyframes are selected so that they are sufficiently distant from each other in order to maximize the quality of the triangulation but not too distant to be able to ensure their matching.

The 3D-point triangulation aims at finding the 3D position of points detected and then paired in at least two images of the video.

The method operates incrementally and, when a new keyframe is added, new 3D points are reconstructed.

The article entitled “Generic and Real-Time Structure from Motion” by E. Mouragnon, M. Lhuillier, M. Dhome, F. Dekeyser, and P. Sayd, BMVC 2007—British Machine Vision Conference” discloses the previous steps.

Step E12 also takes into account image data provided by the vision sensor 1 fitted to the vehicle. Step E12 makes use of a base of geo-referenced visual landmarks and performs a recognition of viewpoints. Step E12 results in 2D-3D correspondences that constitute absolute constraints.

Points of interest detected in an image are compared with the landmarks of the base of geo-referenced landmarks. Their geo-referencing then makes it possible to determine an absolute positioning of the vision sensor having acquired the studied image.

Steps E11 and E12 are followed by a step E13 of optimizing constrained bundles by adjustment.

The optimization step E13 is an adjustment of constrained bundles that takes into account the constraints determined in steps E11 and E12, as well as constraints defined from the scene model MS, and constraints defined from data derived from at least one equipment among the inertial unit 4 and the satellite navigation module 2 fitted to the vehicle.

Step E13 results in first vehicle localization data.

The bundle adjustment is a non-linear optimization process that consists in refining the positions of the vision sensor 1 in motion and 3D points by measuring the re-projection error. This step is very expensive in calculation time since the number of variables to be optimized can be very large. In order to remain compatible with the real-time constraint, the bundle adjustment is carried out locally in order to optimize only the last positions of the camera 1, associated as an example with the last three keyframes and the 3D points observed by the camera from these positions. The complexity of the problem is thus reduced without significant loss of accuracy compared to a bundle adjustment carried out on all the positions of the vision sensor and all the 3D points.

Taking into account the MS scene model results in the association of the points of interests previously detected in step E11 with elements of the MS scene model. The bundle adjustment is therefore carried out by taking into account an overall coherence of the points of interest and elements of the MS scene model.

The constraints defined from data derived from at least one equipment among the inertial unit 4 and the satellite navigation module 2 are used to test the coherence of the process.

The inertial unit 4 and the satellite navigation module 2 provide localization data that may be biased. Step E14 of correcting the sensor biases is performed in parallel with step E13.

Generally, a satellite navigation module bias results in a continuous time error, that may be equivalent to several seconds, of the localization provided along one direction. The geo-referenced visual landmarks and the scene model are used to detect and correct this bias. For example, for a vehicle remaining on a traffic lane, if the satellite navigation module provides position data corresponding to the interior of the buildings, the error can be estimated and compensated.

For the inertial unit, it is rather a static drift or an angle bias on a “real” trajectory. These biases are identifiable and correctable by the use of the visual landmarks and the scene model.

FIG. 4 represents an embodiment of step E2 of Bayesian-filtering the set of data.

The Bayesian filtering is a Kalman filter that is a recursive estimator conventionally including two phases: prediction and innovation or update.

The input data include:
the first vehicle localization data provided by step E1,
data of the scene model.

The input data also include data among:
data derived from the satellite navigation module 2,
data derived from the odometric sensor 3,
data derived from the inertial unit 4.

The first vehicle localization data provided by step E1, the data of the scene model, and possibly the data derived from the satellite navigation module 2 are used in the innovation phase.

The data derived from the odometric sensor 3 and/or the data derived from the inertial unit 4 are used in the prediction phase of the Bayesian filter. If the data of these sensors are not available, a predictive model is used in the Bayesian filter prediction phase. The predictive model is for example defined by: constant speed or constant acceleration.

The prediction phase uses the estimated state of the previous instant to produce an estimate of the current state. In the innovation phase, the observations of the current state are used to correct the predicted state in order to obtain a more accurate estimate.

1. A method for localizing a vehicle including at least one vision sensor and at least one equipment among an inertial unit, a satellite navigation module and an odometric sensor, the method comprising:
vision-localization from image data provided by the at least one vision sensor, to produce first localization data,
the vision-localization including:
determining relative vision constraints by a method for simultaneous localization and mapping applied to the image data produced by the at least one vision sensor,
determining absolute vision constraints by recognition of viewpoints from image data produced by the at least one vision sensor and a base of visual landmarks,
adjusting constrained bundles taking into account the relative and absolute vision constraints, constraints defined from a scene model and constraints defined from data produced by at least one equipment among the inertial unit and the satellite navigation module; and
Bayesian filtering by a Kalman filter taking into account the first localization data, data derived from the at least one equipment and data of the scene model, to produce second vehicle localization data.

2. The method for localizing a vehicle according to claim 1, wherein the vision-localization further includes:
correcting the sensor biases using the visual landmark base and the scene model.

3. The method for localizing a vehicle according to claim 1, wherein the Bayesian filtering by the Kalman filter also takes into account data among:
data derived from the satellite navigation module,
data derived from the odometric sensor,
data derived from the inertial unit.

4. The method for localizing a vehicle according to claim 1, wherein the determining relative vision constraints includes:
detecting and matching points of interest in images provided by the at least one vision sensor,
calculating the installation of the vision sensor from the matching of points of interest,
selecting keyframes,
triangulating 3D points.

5. A device for localizing a vehicle including at least one vision sensor, at least one equipment among an inertial unit, a satellite navigation module and an odometric sensor, and means for:
vision-localization from image data provided by the at least one vision sensor, to produce first localization data,
the vision-localization means includes means for:
determining relative vision constraints by a method for simultaneous localization and mapping applied to the image data produced by the at least one vision sensor,
determining absolute vision constraints by recognition of viewpoints from image data produced by the at least one vision sensor and a base of visual landmarks,
adjusting constrained bundles taking into account the relative and absolute vision constraints, constraints defined from a scene model and constraints defined from data produced by at least one equipment among the inertial unit and the satellite navigation module; and
Bayesian filtering means implementing a Kalman filter taking into account the first localization data, data derived from the at least one equipment and data of a scene model, to produce second vehicle localization data.

6. A non-transitory computer-readable medium including computer executable instructions, wherein the instructions, when executed by a computer, cause the computer to perform the method of claim 1.

7. A non-transitory computer-readable medium including computer executable instructions, wherein the instructions, when executed by a computer, cause the computer to perform the method according to claim 2.
